(19) United States
(12) Patent Application Publication
(10) Pub. No.: US 2014/0105587 A1
(43) Pub. Date: Apr. 17, 2014

(54) MIRROR ATTACHMENT FOR SELF PORTRAIT PHOTOGRAPHY WITHOUT PARALLAX

(71) Applicant: Blake Bogdanovich, Granada Hills, CA (US)

(72) Inventor: Blake Bogdanovich, Granada Hills, CA (US)

(21) Appl. No.: 13/897,226

(22) Filed: May 17, 2013

Related U.S. Application Data
(63) Continuation of application No. 11/228,211, filed on Sep. 15, 2005, now abandoned.

(51) Int. Cl. G03B 13/14; G03B 17/56

(52) U.S. Cl. CPC G03B 13/14; G03B 17/565
USPC 396/376; 396/544

(57) ABSTRACT

An after-market product for attachment to a camera, lateral to a lens of the camera to enable photographing a self portrait while avoiding parallax error includes a mirror having a convex front surface and a plane rear surface; an adhesive layer engaged with the rear surface; a peelable cover sheet engaged with the adhesive layer; and a clear film layer having framing marks, the film layer adhesively engaged with and re-engagable with the front surface for repositioning the framing marks so as to avoid parallax error.

### INCORPORATION BY REFERENCE TO ANY PRIORITY APPLICATIONS

The present application is a continuation of U.S. patent application Ser. No. 11/228,211 filed on Sep. 15, 2005, this application any and all applications for which a foreign or domestic priority claim is identified in the Application Data Sheet as filed with the present application are hereby incorporated by reference under 37 CFR 1.57.

### BACKGROUND OF THE INVENTION

1. Field of the Invention

This disclosure relates generally to a portable camera capable of taking still or motion pictures and to an after market framing mirror adapted for attachment to the front face of the camera.

2. Description of the Related Art

Chauhan, U.S. 2004/0170422, discloses a camera lens window with one or more mirrors surrounding it in a portable camera or particularly in a mobile camera telephone. When taking a self-portrait, a user can confirm the correct alignment of the self-portrait if he or she can see parts of his or her head in the mirror image surrounding a hole therein caused by lens window. Simjian, U.S. Pat. No. 1,709,598, discloses a pose-reflecting system for photographic apparatus, the combination with a camera and a lens-system thereof; of mirror-guiding means; a mirror-unit normally located in front of the lens-system to prevent the image of a person to be photographed from being recorded by the camera, and movable under the guidance of the mirror-guiding means from the normal position to permit the image to be recorded by the camera; whereby a person to be photographed may, beforehand, observe an accurate reflection of the image which the camera will record when the mirror is moved from its normal position. Pinkosh, U.S. Pat. No. 1,879,949, discloses a portable camera having a lens adjacent to a wall thereof for focusing an image upon a film or plate at the side of the lens opposite the image, of a convex finder rectangular in outline in proximity to the wall and arranged at a side of the lens out of alignment therewith, the finder mirror being adapted to make the image of a person being photographed visible to the person at a location upon the convex finder mirror substantially similar to the location at which the image is focused upon the film or plate, and the side edges of the mirror being adapted to serve as guides for situating the camera in a horizontal position. Gwozdecki, U.S. Pat. No. 1,992,068, discloses a camera that is provided with an objective, a finder assembly comprising a convex mirror having a central opening therein, a means for supporting the mirror in front of the objective so that the optical axis of the opening, the convex mirror having a curvature conforming to the equation R is grater than or equal to 2 f where R is the radius of curvature of the mirror and f is the focal length of the objective, and a plurality of lines provided on the convex face of the mirror hand closing spaces whose areas correspond to the true images obtained at varying distances from the objective. Wheelan, U.S. Pat. No. 2,224,579, discloses a pose reflecting photographic apparatus comprising, in combination, a camera, a transparent reflector positioned in the path of light between the camera and a posing subject, and a walled cabinet structure snugly embracing the camera and extending forwardly from the reflector to cut off the passage of light from behind the reflector to the subject. Mosca, U.S. Pat. No. 2,531,783, discloses a stenoscopic camera comprising in combination a wall with a ‘very small image-creating stenoscopic entrance opening acting as “pinhole lens;” a converging mirror arranged in the stenoscopic camera with its axis inclined to the axis of the very small image-creating stenoscopic entrance opening in the path of the rays entering the stenoscopic camera through the very small image-creating stenoscopic entrance opening; a diverging mirror arranged in the stenoscopic camera in the path of the rays reflected by the converging mirror with its axis inclined to the axis of the very small image creating stenoscopic entrance opening and to the axis of the converging mirror; and a carrier for a photosensitive surface arranged in the stenoscopic camera in a path of the rays reflected by the diverging mirror inclined to the axis of the diverging mirror. Tanaka et al., U.S. Pat. No. 4,490,029, discloses a framing mirror that is provided on the front part of a camera for enabling observation of the range of the scene to be photographed from the front of the camera is used for various displays by a liquid crystal display device. Various operation modes are set by a mode selection member and the state of the display portion of the liquid crystal display device arranged in front of the framing mirror changes in accordance with the set operation mode to effect various displays. In at least one of the operation modes the whole display portion of the liquid crystal display device becomes transparent, whereby it is possible to observe the framing mirror from the front of the camera. Alternatively, the framing mirror has a transparent portion at a marginal position and the liquid crystal display device is arranged behind the transparent portion so as to be observable from the front of the camera. The liquid crystal display device displays the same data as displayed by another liquid crystal display device which is arranged behind the framing mirror, for recording data on a photographic film. Ueda et al., U.S. Pat. No. 4,560,261, discloses a camera for use with a disk film having a take lens window provided in the front side of a parallelepipedal housing closer to one lateral side thereof and a mirror device disposed at the center of the front side adjacent the window for observing the object. The mirror device is variable in its inclination to correct the parallax due to a variation in the distance of the object and has framing marks for indicating the field of view of the lens which differs with the object distance. The mirror device further has a coverage recognition sign which is observable only from a predetermined position within the coverage where an image of the object can be accurately observed on the device. Leuer, U.S. Pat. No. 4,999,657, discloses a mirror that is secured to a camera and adjusted so that a subject being photographed can see himself or herself in the mirror when the photograph is taken. The subject can take his or her own photograph, if desired. A mounting bracket is provided which can be secured to the camera after the camera is purchased. The mirror is easily secured to the mounting bracket for use, and can be readily removed for storage and transportation. Seya et al., U.S. Pat. No. 5,619,295, discloses a camera cover that is attached to an existing camera, so that the user can take a photograph of himself or herself with an intended camera angle, scope and timing. A camera cover body, which comprises the camera cover to be removably attached to a camera, has a front portion covering a front side of the camera. The front portion is formed in a shape of a convex spherical surface and has an aperture in a position corresponding to a lens of the camera. A reflecting layer is formed on an inside of the front portion by aluminum evaporation, etc. The whole part of the front portion structures a convex mirror. Aizawa et al., U.S. Pat. No. 6,496,657, discloses a camera that includes: a distance measuring device for measuring an object distance; a photometry device for measuring an object brightness; a mode setting device for setting a self portrait photographic mode to set a photographic condition appropriate for photographing a photographer oneself holding the camera; and a controller for controlling to perform photographing without conducting at least one of the measurement by the distance measuring device and the measurement by the photometry device when the self portrait photographic mode is set by the mode setting device. Kawamura, E.P. 1052537, discloses a focusing position selecting mechanism for determining focusing positions of a taking lens is provided with a selector member for selecting among a plurality of focusing positions including a focusing position for close-up photographing. In the front portion of the photographing unit a mirror is provided fixedly beside a finder window, and the photographer can take a picture of an object form the front with himself included in the composition by watching the mirror. On the front portion of the apparatus is indicated a focusing state of normal photographing so that the photographer may not make a mistake in photographing from the front at the normal focusing position.

Our prior art search described above teaches the use of convex lenses mounted to the front face of cameras, including cell phone cameras, for enabling self portrait. Such lenses may have framing marks for indicating the extend of a photograph taken at various distances and such mirrors may be mechanically attached to the front of a camera after the camera is purchased. The prior art fails to teach the use of an after-market product that is a convex-plano mirror with an adhesive backing wherein with a cover paper removed from the backing an adhesive surface is uncovered which may be used to secure the mirror to the front face of a camera. The mirror is preferably made of polycarbonate plastic with a silvered plano surface. The mirror also has anti-reflection and hard coating layers deposited onto the convex surface. The convex surface of the mirror has a clear plastic sheet adhered to it and this sheet has framing marks printed on it. However, the clear sheet may be peeled off the mirror and reapplied according to directions with the product to avoid parallex errors. The present disclosure distinguishes over the prior art providing heretofore unknown advantages as described in the following summary.

### SUMMARY

This disclosure teaches certain benefits in construction and use which give rise to the objectives described below.

An after-market product for attachment to a camera, lateral to a lens of the camera to enable photographing a self portrait while avoiding parallax error includes a mirror having a convex front surface and a plane rear surface; an adhesive layer engaged with the rear surface; a peelable cover sheet engaged with the adhesive layer; and a clear film layer having framing marks, the film layer adhesively engaged with and reengagable with the front surface for repositioning the framing marks so as to avoid parallax error.

A primary objective inherent in the above described apparatus and method of use is to provide advantages not taught by the prior art.

Another objective is to enable a well framed self portrait photograph.

A further objective is to enable the custom adjustment of framing marks for each camera using an after-market product attached to the camera.

A still further objective is to enable the custom adjustment of framing marks for each user of a specific camera wherein different users have differing arm lengths.

Other features and advantages of the described apparatus and method of use will become apparent from the following more detailed description, taken in conjunction with the accompanying drawings, which illustrate, by way of example, the principles of the presently described apparatus and method of its use.

### BRIEF DESCRIPTION OF THE DRAWINGS

The accompanying drawings illustrate at least one of the best mode embodiments of the present apparatus and method of it use. In such drawings:

FIG. 1 is a perspective view of the present apparatus in use;

FIG. 2 is a perspective view of a mirror of the invention with a cover film attached;

FIG. 3 is a section view taken along line 3-3 in FIG. 2;

FIG. 4 is a section view taken along line 4-4 in FIG. 3 showing a convex mirror of the present apparatus with an adhesive wedge mounted on a planar rear surface, and further showing a second adhesive wedge adjacent to the first adhesive wedge; and

FIG. 5 is a perspective separated view of one embodiment of the present apparatus showing a camera, a convex mirror with reference alignment lines and a backing cover sheet.

### DETAILED DESCRIPTION

The above described drawing figures illustrate the described apparatus and its method of use in at least one of its preferred, best mode embodiment, which is further defined in detail in the following description. Those having ordinary skill in the art may be able to make alterations and modifications what is described herein without departing from its spirit and scope. Therefore, it must be understood that what is illustrated is set forth only for the purposes of example and that it should not be taken as a limitation in the scope of the present apparatus and method of use.

The presently described apparatus, in one embodiment, is an after-market product, a mirror 10 that is purchased separately from a camera 20 and then attached to the front of the camera 20 so that a subject 5 may easily take a self portrait by framing her image in the mirror 10. The mirror 10 is capable of being adhered to any hand held camera 20 that has a front face 22 with a flat surface 24 to which the mirror 10 is secured. Such a front face 22 must be normal to the axis of the camera lens 26 so that the mirror 10 faces the subject 5 being photographed. If the front face 22 is not normal to the photographic axis, the mirror 10 cannot be used to position the camera 20 correctly. The use of the word “camera” in this disclosure shall be taken to mean any photographic device and may be, for instance, a hand-held camera, a camera on a tripod, a cell phone with photographic capability, etc., and such camera may use photographic film or may be a digital device.

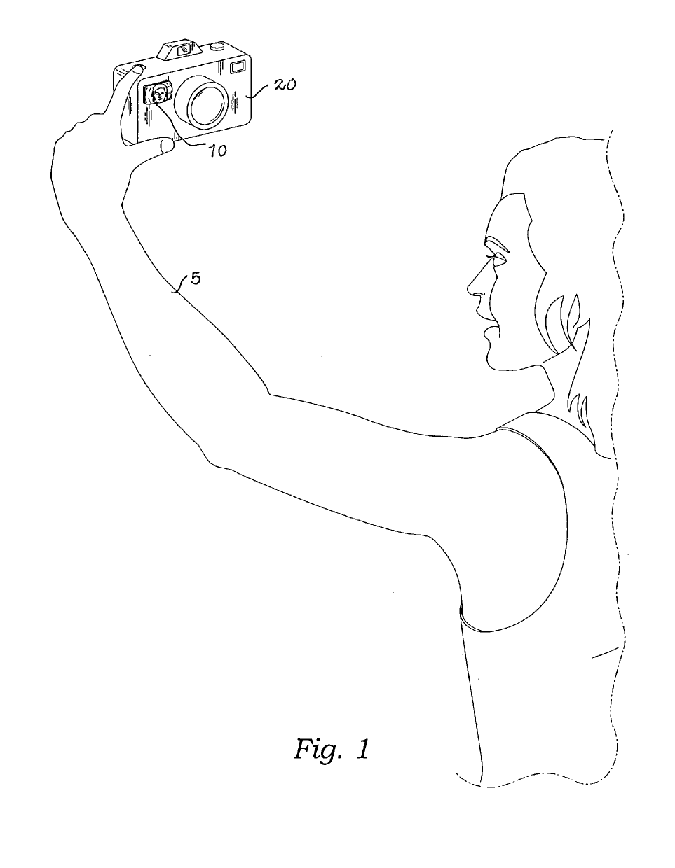

The mirror 10 is placed on the surface 24, by necessity, in a position that is lateral to the lens 26 as shown in FIGS. 1 and 5 since the mirror 10 cannot be placed over the photographic lens 26 without obscuring it. Since the subject is, at least when the camera is hand held, at close range, the subject's image, when centered in the mirror 10, will not be centered in the lens 26. This small difference is a parallax error, i.e., the subject will not be centered in the resultant photograph.

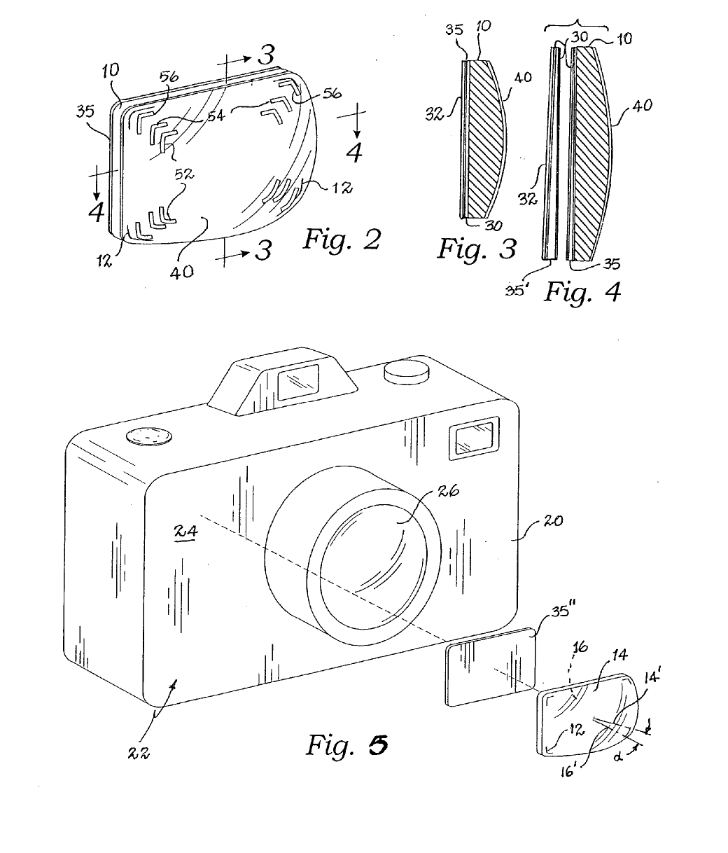

To correct for parallax error, the subject must consciously move her image to one side in the mirror 10, and if the mirror 10 has primary framing marks 12, as shown in FIGS. 2 and 5, the subject may be able to take a photograph with her image centered in the photograph by placing her image off center in the mirror 10 using the framing marks 12 to judge how far off center to move her image, but such skill is only developed after taking at least several test photographs. This adaptive skill process would need to be repeated by each subject using the camera 20. In order to avoid such adaptive positioning of the subjects image off center in the mirror 10, a solution is presented herein and is described below.

Mirror 10 has a convex front surface 14 and a planar rear surface 16 as shown in FIG. 5. The primary framing marks 12 define a rectangular surface on the mirror 10, and these marks may be scribed into the mirror surface 14 or may be printed onto the mirror surface. In use, the subject composes her photo by moving the camera to place her image within the area defined by marks 12, but as stated, adjusted out of center in the rectangular surface defined by marks 12 in order to be assured of being centered in the resultant photograph.

In one embodiment of the present apparatus, an adhesive layer 30 is engaged with the rear surface 16, and a cover sheet 32 is engaged with the adhesive layer 30, the cover sheet 32 being easily peeled away from the adhesive layer 30. A wax covered paper is typically used for this purpose and this cover sheet 32 prevents the adhesive layer 30 from coming into contact with any surface prior to being set against the camera surface 24 for mounting the mirror 10 onto the camera 20.

In the preferred embodiment however, instead of a simple adhesive layer 30, a wedge shaped layer 35 is preferably substituted, as shown in FIG. 4. Such a wedge shaped layer 35 is able to tilt the mirror 10 so that with the camera positioned at a selected distance from the subject, the subject's image will appear centered in the framing marks 12. The wedge shaped layer 35 may be made from a calendared paper stock so as to have a uniformly varying thickness as shown in FIG. 4. Preferably the after-market product may include several identical wedge shaped layers 35, where, to obtain an appropriate degree of tilt of the mirror 10 more than one of the layers 35 may be used, i.e., built up to the desired tilt angle and thereby enabling the mirror 10 to compensate for parallax. Alternately, the after-market product may include several wedge shaped layers 35, 35′ and so on, of different thicknesses (two shown in FIG. 4) so that if one is insufficient to achieve the necessary tilt angle, a different (thicker or thinner) wedge shaped layer may be used. The wedge shaped layers 35 and 35′ are shown with adhesive on both sides in FIG. 4, and layer 35′ is also shown with a paper peel-off cover sheet 32. In a still further preferred embodiment the mirror 10 has a convex front surface 14 and a planar rear surface 16 as stated, however, a normal 16′ to the rear surface extended outwardly from the convex surface 14, and a line 14′ defining a center of symmetry of the convex surface 14 and extending outwardly therefrom, form an acute angle α. This is a substitute for placing a wedge shaped layer 35, or 35′ (FIG. 4) on the planar surface 16 of the mirror 10 so that simple double sided tape 35″, having a uniform thickness may be used to affix the mirror 10 to the camera 20 while still attaining the repositioning of the subject's image in the mirror 10 appropriate to reduction or elimination of parallax error. Please refer to FIG. 5.

A clear film layer 40 such as one made from a thin layer of electrostatic vinyl plastic film is provided with or without (FIG. 4) an adhesive backing 30 and is positioned into contact with the convex surface 14 of the mirror 10. In the case where an adhesive is used, it is one that may be peeled away from the mirror 10 without leaving a residue, and readhered many times without loosing its adhesive strength. Electrostatic vinyl plastic film is well known and will adhere to the mirror 10 quite readily. The clear film layer 40 provides plural sets of secondary framing marks 52, 54 and 56, as shown in FIG. 2. Each set of the framing marks comprises four marks, the marks defining the corners of a rectangular area on the surface of the mirror 10 and each of these sets of marks defines an area that is different in size from the others, as shown with marks 52 defining the smallest rectangle, marks 54 defining an intermediate sized rectangle, and marks 56 defining a largest rectangle.

Without tilting the mirror 10, the secondary framing marks 52, 54, and 56 may be used to position the subject's image on the mirror 10 so as to compensate for parallax. To accomplish this, the film layer 40 is repositioned on the surface of the mirror 10 such that the secondary framing marks 52, 54, and 56 are repositioned off center on the mirror 10 at a position that allows the subject's image to be centered in the secondary framing marks and also in the resulting photograph for a given lens to subject distance. Such a repositioning is advantageously accomplished using the primary framing marks 12 as a reference or guide during repositioning. Without the primary framing marks 12 it is much harder to reposition the film 40.

In an alternate embodiment of the present apparatus the camera 20 provides permanent mounting and placement of mirror 10 on its front surface 22. The camera 20 and mirror 10 comprise a new product and not one for the after-market as described above. In this embodiment, the mirror 10 carries the primary framing marks 12 as described above, and the clear film 40 carries the secondary framing marks 52, 54, 56 as well.

The enablements described in detail above are considered novel over the prior art of record and are considered critical to the operation of at least one aspect of the apparatus and its method of use and to the achievement of the above described objectives. The words used in this specification to describe the instant embodiments are to be understood not only in the sense of their commonly defined meanings, but to include by special definition in this specification: structure, material or acts beyond the scope of the commonly defined meanings. Thus if an element can be understood in the context of this specification as including more than one meaning, then its use must be understood as being generic to all possible meanings supported by the specification and by the word or words describing the element.

The definitions of the words or drawing elements described herein are meant to include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements described and its various embodiments or that a single element may be substituted for two or more elements in a claim.

Changes from the claimed subject matter as viewed by a person with ordinary skill in the art, now known or later devised, are expressly contemplated as being equivalents within the scope intended and its various embodiments. Therefore, obvious substitutions now or later known to one with ordinary skill in the art are defined to be within the scope of the defined elements. This disclosure is thus meant to be understood to include what is specifically illustrated and described above, what is conceptually equivalent, what can be obviously substituted, and also what incorporates the essential ideas.

The scope of this description is to be interpreted only in conjunction with the appended claims and it is made clear, here, that each named inventor believes that the claimed subject matter is what is intended to be patented.

1. An after-market product for attachment to a camera, lateral to a lens of the camera to enable photographing a self portrait while avoiding parallax error, comprising:
a mirror having a convex front surface and a planar rear surface;
at least one wedge shaped layer engaged with the rear surface;
a clear film layer engaged with the front surface, the clear film layer repositionable on the front surface for adjusting positions of a set of secondary framing marks on the front surface so as to avoid parallax error.

2. The after-market product of claim 1 wherein the front surface has primary comer reference marks.

3. The after-market product of claim 1 wherein the secondary framing marks of the film layer comprise at least two sets of four-comer indicia.

4. The after-market product of claim 1 wherein the at least one wedge shaped layer provides opposing adhesive surfaces.

5. The after-market product of claim 1 wherein the clear film is an electrostatic cling film.

6. An after-market product for attachment to a camera, lateral to a lens of the camera to enable photographing a self portrait while avoiding parallax error, comprising:
a mirror having a convex front surface and a planar rear surface;
a plurality of one wedge shaped layers, each of the layers providing a different wedge angle.

7. The after-market product of claim 6 further comprising: a clear film layer engaged with the front surface, the clear film layer repositionable on the surface so as to avoid parallax error.

8. The after-market product of claim 7 wherein the clear film is an electrostatic cling film.

9. The after-market product of claim 6 wherein the front surface has primary comer reference marks.

10. The after-market product of claim 7 wherein the secondary framing marks of the film layer comprise at least two sets of four-comer indicia.

11. The after-market product of claim 6 wherein the wedge shaped layer provides opposing adhesive surfaces.

12. A camera comprising:
a mirror presenting a convex front surface positioned laterally to a lens of the camera on a front of the camera;
a clear film layer having secondary framing marks thereon, the film layer engaged with the front surface of the mirror by an adhesive mechanism capable of engagement between the mirror and the film layer after the film is removed from the mirror and repositioned thereon a plurality of times.

13. The camera of claim 12 wherein the front surface of the mirror has primary comer reference marks thereon.

14. The after-market product of claim 1 wherein the secondary framing marks of the film layer comprise at least two sets of four-comer indicia.

15. (canceled)
